(19) United States
(12) Patent Application Publication
(10) Pub. No.: US 2025/0199851 A1
(43) Pub. Date: Jun. 19, 2025

(54) SYSTEM, APPARATUS AND METHOD FOR SCHEDULING INSTRUCTIONS BASED ON CRITICAL DEPENDENCE

(71) Applicant: Intel Corporation, Santa Clara, CA (US)

(72) Inventors: Wing Shek Wong, Austin, TX (US); Vikash Agarwal, Austin, TX (US)

(21) Appl. No.: 18/545,236

(22) Filed: Dec. 19, 2023

(51) Int. Cl. G06F 9/48; G06F 9/50

(52) U.S. Cl. CPC G06F 9/4881; G06F 9/5038

(57) ABSTRACT

In one embodiment, a method includes: receiving, in a scheduler circuit of a processor, an incoming micro-operation (μop); determining whether the incoming μop is dependent on a first μop stored in the scheduler circuit; and in response to determining that the incoming μop is dependent on the first μop, updating an entry in the scheduler circuit associated with the first μop to indicate that the first μop has at least one dependent μop. Other embodiments are described and claimed.

### BACKGROUND

In modern out-of-order processors, an instruction scheduler is responsible for picking and dispatching micro-operations (micro-ops or μops), which are decoded from macro-instructions, for execution. Conventionally, due to timing, complexity, and area reasons, a selection determination is usually based on age and readiness of micro-ops residing in a reservation station. That is, the oldest ready micro-op is picked among all ready micro-op candidates. However this selection sequence may be sub-optimal in certain situations.

### BRIEF DESCRIPTION OF THE DRAWINGS

FIG. 1 is a flow diagram of a method in accordance with an embodiment.

FIG. 2 is a block diagram of a portion of a processor pipeline in accordance with an embodiment.

FIG. 3 is a flow diagram of a method in accordance with another embodiment.

FIG. 4 illustrates an example computing system.

FIG. 5 illustrates a block diagram of an example processor in accordance with an embodiment.

FIG. 6 is a block diagram of a processor core in accordance with an embodiment.

### DETAILED DESCRIPTION

In various embodiments, a processor includes an instruction scheduler that incorporates real-time dynamic dependence information into an out-of-order scheduler selection algorithm. In one or more embodiments, the scheduler may select a next μop for providing to an execution unit based at least in part on age, readiness and dependency information.

In this way and by prioritizing a selection of a micro-op in a critical dependence chain to execute early over an older micro-op that is not in this critical dependence chain, overall execution speed of a workload increases. This is so, because the critical dependence chain dictates the duration of completion of a workload.

Different manners of identifying dependency can be performed in different embodiments. In one implementation, a receipt of a younger incoming μop to the reservation station may trigger a dynamic update to critical dependence information of one or more older micro-ops in the reservation station. This information is later used in scheduling these critical μops over older micro-ops.

Referring now to Table 1, shown is an example of assembly code that illustrates a scheduling savings using an embodiment.

TABLE 1

Init:
MOV RAX,[mem]
MOV RBX, 0x1000
Start:
// 20 LEA
lea R8,[RAX+1] // 1st LEA
lea R8,[RAX+1] // 2nd LEA
....
lea R8,[RAX+1] // 80th LEA
add RAX,RAX
add RAX,RAX
add RAX,RAX
add RAX,RAX
sub RBX,1
jnz Start

Without an embodiment, this code executes in 7 cycles. This is so, as the younger ADD does not start execution until LEA completes (4 cycle) since LEAs are older. It takes 10 cycles for the serial dependent ADD to execute.

Instead with an embodiment, the code executes in 4 cycles. This is so since the younger ADD's start to execute immediately because ADD has a higher priority to arbitrate and execute (than older LEAs) because ADD is feeding the next ADD in the dependence chain. So ADD's execute every cycle instead of waiting for the LEA's and so 4 cycles can be overlapped. Without an embodiment, the code slows down 75% from 4 cycles to 7 cycles (7/4=1.75).

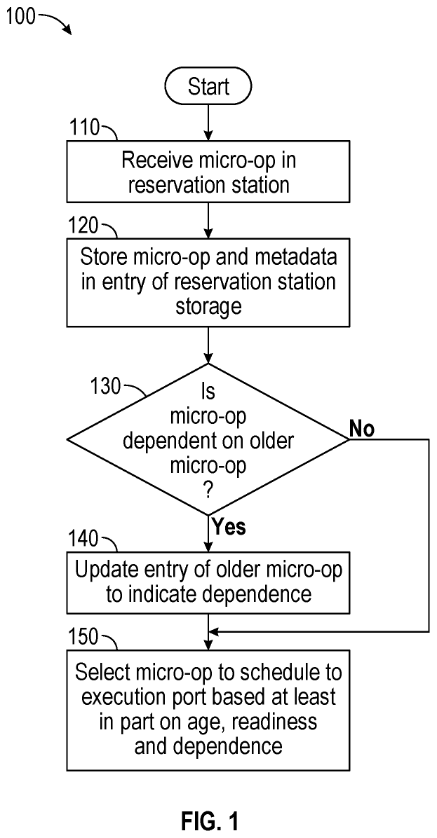

Referring now to FIG. 1, shown is a flow diagram of a method in accordance with an embodiment. More specifically, method 100 of FIG. 1 is a method for scheduling instructions for execution based on dynamic information regarding instruction dependence. Method 100 may be performed by hardware circuitry, such as may be included in a scheduler circuit. In some implementations method 100 may be performed by this hardware circuitry alone and/or in combination with firmware and/or software.

As illustrated common method 100 begins by receiving a μop in a reservation station (block 110). Next at block 120 this μop is stored into an entry of a storage of the reservation station along with metadata of the μop. For example, this metadata may include fields for various information associated with the μop, including source and destination operands (e.g., in the form of physical register identifiers). In addition, each entry may further include fields to identify a status of the μop, such as a readiness indicator to indicate that the μop is ready for scheduling when all source operands are available.

In addition, each entry may include a dependency indicator to store a value to indicate whether any pending μops in the reservation station are dependent on this μop. Note that this dependency indicator is thus a value that is updated when a new incoming μop is stored in the reservation station. Specifically, this dependency indicator is set by a later consumer μop that depends on this μop. Thus as shown in FIG. 1, at diamond 130 when an incoming μop is received in the reservation station, it is determined whether this μop is dependent on an older μop. If so, control passes to block 140 where the entry in the reservation station for the older producer μop can be updated to indicate this dependence. In an embodiment a dependency indicator may be a one bit field which when set indicates that at least one μop is dependent on the result of the stored μop.

Still with reference to FIG. 1, at block 150 during a scheduling process within the scheduler circuitry, a μop is selected for scheduling to a given execution port based at least in part on this dependence indicator, along with age and readiness information. Details of this scheduling process are described further herein. Also understand while all of this information may be used for scheduling at least some μops, other μops can be scheduled, e.g., another path, that do not take into account the dependence information. Although shown at this high level in the embodiment of FIG. 1, many variations and alternatives are possible.

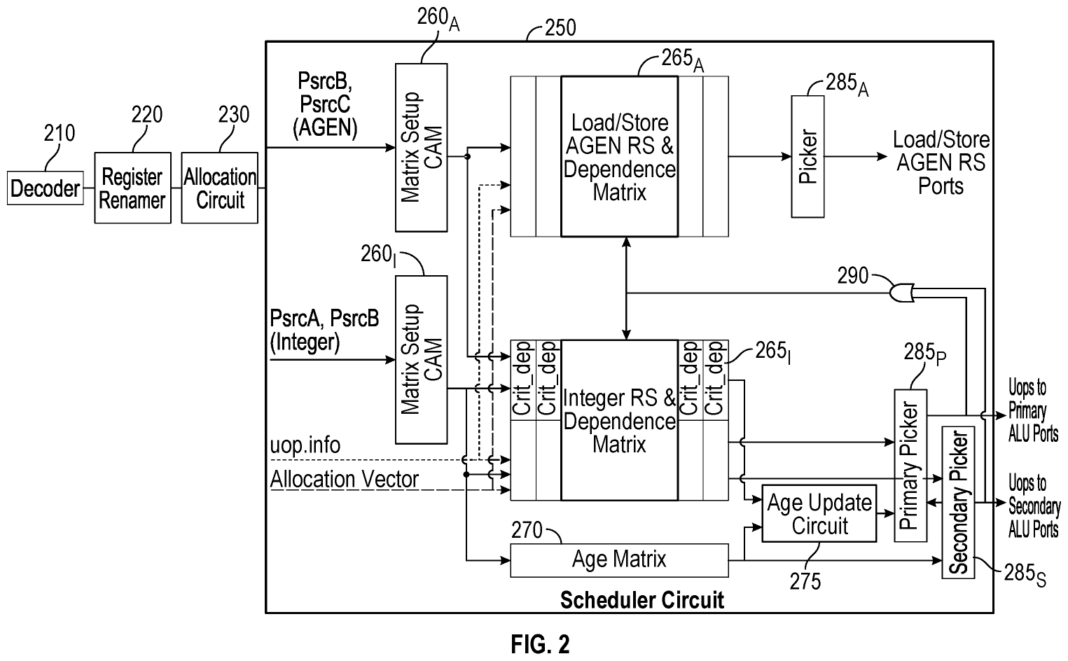

Referring now to FIG. 2, shown is a block diagram of a portion of a processor pipeline in accordance with an embodiment. As shown in FIG. 2, portion of a processor 200 is illustrated. As seen, a decoder 210 receives incoming instructions, e.g., in the form of macro-instructions, and decodes them into one or more μops. In turn these μops are provided to a register renamer 220, which may perform register renaming to take logical register identifiers of the operands and provide physical register identifiers. In turn, this information is provided to an allocation circuit 230, which allocates μops to a scheduler circuit 250.

As shown in FIG. 2, scheduler circuit 250 is implemented as a matrix-based scheduler. During allocation, micro-ops are allocated into a reservation station 265. More specifically, reservation station 265 may be implemented with multiple storages, including a first portion 265_{A} to store load/store address generation (AGEN) and related information. Note that reservation station 265 may be implemented as a dependence matrix, with the inclusion of dependence information as described herein. Similar information is stored for integer information into reservation station 265_{I}. As shown, various physical sources are coupled through separate content addressable memories (CAMs) 260_{A, I} and then provided to reservation stations 265_{A, I}. In addition to the μops themselves, additional information including the metadata as described herein may also be stored along with information from an allocation vector (e.g., a write pointer to indicate which entry of reservation station 265 to write to).

In the matrix-based scheduler shown in FIG. 2, an age matrix 270 may be implemented as a separate storage to store a matrix to maintain relative age information of the various μops. In operation, source dependence is checked against all queued micro-ops in reservation station 265 during setup operation of the matrix of reservation station 265, to create information for waking up a micro-op when its parent micro-op executes.

As illustrated in FIG. 2, critical dependence information is annotated to queued micro-ops in reservation station 265 dynamically when incoming micro-ops allocate in-order. An older micro-op is marked with a dependence indicator as being critical if there is a younger micro-op that is dependent on the result of the older micro-op (in certain embodiments there may be certain conditions to be met before indicating an older μop with the dependence indicator, as described below).

In embodiments, this dependence indicator (also referred to herein as a “critical dependence hint”) may be set in an entry of one or more stored μops in the dependence matrix of reservation station 265 when a newly allocated micro-op is received.

A queued micro-op in reservation station 265 being “hit” from an incoming micro-op (i.e. allocating micro-op source operand matching producer micro-op in reservation station 265) means that the queued micro-op has a child dependent micro-op. Therefore, queued micro-ops (hit by younger allocating child micro-ops) are marked with the critical dependence hint field in reservation station 265.

In FIG. 2, micro-ops in the same allocation cycle with concurrent dependence also create the critical dependence hint correctly. As an example, assume that up to 8 μops can be allocated into reservation station 265 in a single cycle, and that μop 6 depends on μop 0. With embodiments, μop 0 will have a critical dependence hint as a result of μop 6.

In the embodiment of FIG. 2, age matrix 270 is used to maintain age information between micro-ops in reservation station 265. In one or more embodiments, age matrix 270 is implemented as a two-dimensional structure, where age_matrix[i][j]=1 means entry i is older than entry j, such that each entry identifies a relative age of a μop with respect to other pending μops in reservation station 265.

In the embodiment of FIG. 2, critical dependence-based scheduling is implemented in an integer ALU scheduler, namely a primary picker 285p. Of course in other implementations, additional or different scheduler circuitry can implement the disclosed scheduling techniques. For example, dependent child micro-ops can be an integer ALU micro-ops or AGEN micro-ops of a load/store path.

Also in the embodiment of FIG. 2 with a primary and lazy (1 cycle delay) secondary scheduler topology (where the lazy secondary port only supports single cycle operation), critical dependence-based scheduling is only implemented for single cycle micro-ops on the primary port. This implementation thus prioritizes latency-sensitive critical micro-op for scheduling on primary port, while non-critical micro-ops can be deprioritized to execute on the secondary lazy port, freeing up primary port for critical micro-ops.

In one or more embodiments, the criteria to identify a μop as having a critical dependence can be tuned for performance. Firstly, a critical dependence hint can be refined to exclude flag dependence for performance reasons. For example, assume a branch micro-op depends on a condition flag from a compare micro-op. In some embodiments, flag dependence can be considered to be invalid for critical dependence purpose (while a data dependence is considered as valid dependence). Therefore, an older micro-op is marked as “critical” if there is a younger micro-op depending on its data. However, an older micro-op is not marked as “critical” if there is a younger micro-op depending on its flag.

Secondly, embodiments can identify certain μops as non-bypassable. This identification may be implemented with a bypassable indicator set within an entry of the reservation station for a μop. An older “non-critical” bypass-able micro-op has a lower priority in a selection algorithm as compared to a younger “critical” micro-op. However, an older “non-critical” non-bypass-able micro-op still has higher priority as compared a younger “critical” micro-op. In one or more embodiments, non-bypass-able micro-ops include long latency micro-ops and other single cycle micro-ops implemented only on the primary port. The goal of this feature is to maintain fairness and avoid starvation.

In some cases, entries in age matrix 270 can be modified to update age information based on dependence information. However in the implementation of FIG. 2, information in age matrix 270 is post-processed to create updated age information.

More specifically as shown in FIG. 2, age update circuit 275 is configured to modify age information of μops based on dependence indicators as described herein. In turn, this modified age information is provided to at least primary picker circuit 285p, where the information is used in selecting a next μop to schedule for execution. When performing selection, a “critical” micro-op arbitrates to execute at an elevated priority as compared to a “non-critical” micro-op. For example, a “critical” younger micro-op wins against a “non-critical” older micro-op in a selection process. Micro-ops in the same criticality class obey age ordering. For example, an older “critical” micro-op wins against younger “critical” micro-ops. And, an older “non-critical” micro-op wins against younger “non-critical” micro-ops.

Table 2 below shows pseudo-code of the operation of age update circuit in accordance with an embodiment.

TABLE 2

| | |
|---|---|
| 1. | (RS[i].Crit_dep==0 && RS[j].Crit_dep==0) or |
| | (RS[i].Crit_dep==1 && RS[j].Crit_dep==1) |
| | age_final[i][j]=age_matrix[i][j] |
| 2. | RS[i].Crit_dep==1 && RS[j].Crit_dep==0 |
| | If (RS[j] is bypass-able micro-ops) |
| | age_final[i][j]=1 |
| | Else |
| | age_final[i][j]=age_matrix[i][j] |
| 3. | RS[i].Crit_dep==0 && RS[j].Crit_dep==1 |
| | If (RS[i] is bypass-able micro-ops) |
| | age_final[i][j]=0 |
| | Else |
| | age_final[i][j]=age_matrix[i][j] |

At a high level, the code of Table 2 illustrates how age_final[i][j] is created by merging age information and critical dependence information.

As further illustrated in FIG. 2, picker circuit 285p is coupled to an output of age update circuit 275 to receive age_final[i][j] information. In the embodiment of FIG. 2, this information does not participate in single cycle pick timing loop, therefore critical dependence aware scheduler/picker does not degrade scheduler timing.

As further shown in FIG. 2, the unmodified age information from age matrix 270 is also provided to a secondary picker 285ₛ. Secondary picker 285ₛ may pick μops for scheduling to secondary ALU ports. And as further shown, secondary scheduler 285ₛ can send unselected μops to primary picker 285ₚ. A separate picker 285ₐ selects μops stored in reservation station 265ₐ, for scheduling to load/store ports.

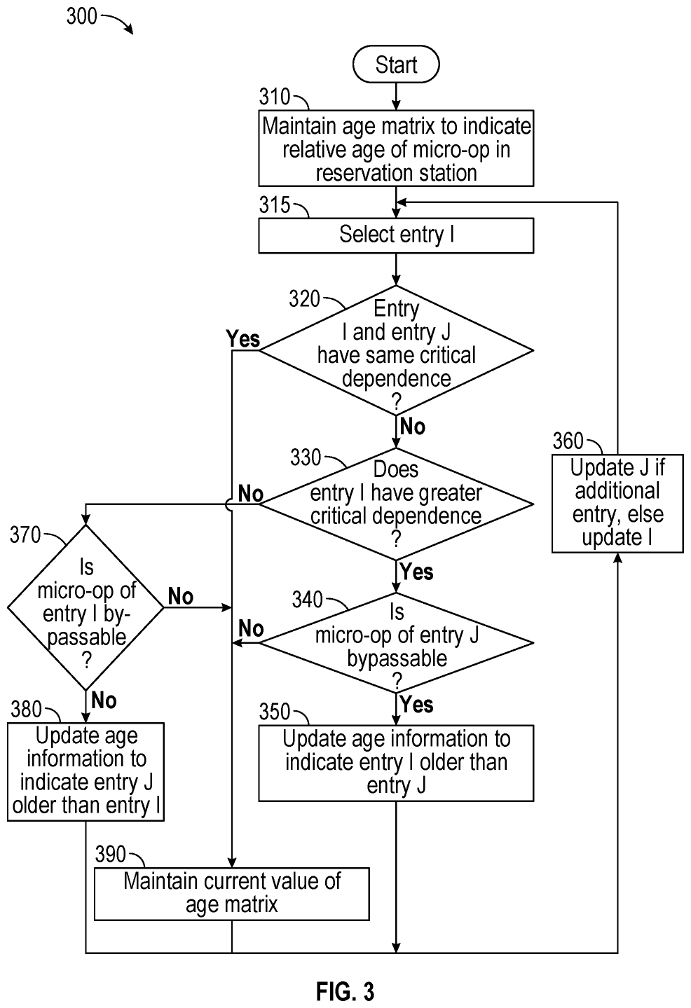

Referring now to FIG. 3, shown is a flow diagram of a method in accordance with another embodiment. More specifically, method 300 of FIG. 3 is a method for dynamically updating age information of a μop based on critical dependence hint information. Method 300 may be performed by hardware circuitry, such as an age modification circuit or other circuit as may be included in a scheduler circuit. In some implementations method 300 may be performed by this hardware circuitry alone and/or in combination with firmware and/or software.

At block 310, the scheduler circuit maintains an age matrix to indicate relative age of μops within the reservation station. This base age information from the age matrix may then be accessed and potentially modified based on a critical dependency hint for a given μop. This analysis, performed within an age adjustment circuit to post-process age matrix information, may begin by selecting a given entry within the age matrix (block 315). Next it is determined whether this entry I and another entry J have the same critical dependence (diamond 320). If so, no change occurs and the current value of the age matrix is maintained and later used for scheduling (block 390). Instead if it is determined that entry I does have a greater critical dependence (as determined at diamond 330), it is next determined at diamond 340 whether the μop of entry J is bypassable. If so, control passes to block 350 where the age information may be updated to indicate that entry I is older than entry J. As discussed above, while this age information update may be performed within the age matrix itself, in the implementation described herein, this updating of age information may be realized by post-processing within the age update circuit

In turn, the modified age information is provided to the picker circuit for use in selecting a next μop. Note that if the μop of entry J is not bypassable, no update occurs (block 390).

Still with reference to FIG. 3, if it is determined at diamond 330 that entry I does not have greater critical dependence, control passes to diamond 370 to determine whether the μop of this entry I is bypassable. If not, no update to the age information occurs. Otherwise if the entry is bypassable, control passes to block 380 where, the age information is updated to indicate that the μop of entry J is older than the μop of entry I.

Finally with further reference to FIG. 3, after a given matrix analysis is performed for a μop pair, control passes to block 360 where an update (increment) to the value of J and/or I may occur to analyze further entries, with control passing back to diamond 315. Although shown at this high level in the embodiment of FIG. 3, many variations and alternatives are possible.

With embodiments that prioritize micro-ops in a critical dependence chain to schedule early, latency to execute the critical dependence chain is reduced, directly improving instructions per cycle (IPC). Embodiments may be especially beneficial in a scheduler supporting dynamic port binding between primary and lazy secondary ports as in FIG. 2. De-prioritized micro-ops can be scheduled on the lazy secondary port, avoiding possible starvation, while at the same time leaving the primary port available to execute latency sensitive critical micro-ops.

While the above implementation describes a single level of prioritization, it is possible to implement more levels of prioritization to further improve performance. In addition, fine tuning of criteria for criticality and bypassability (among others) for micro-op types may further extract additional performance benefits.

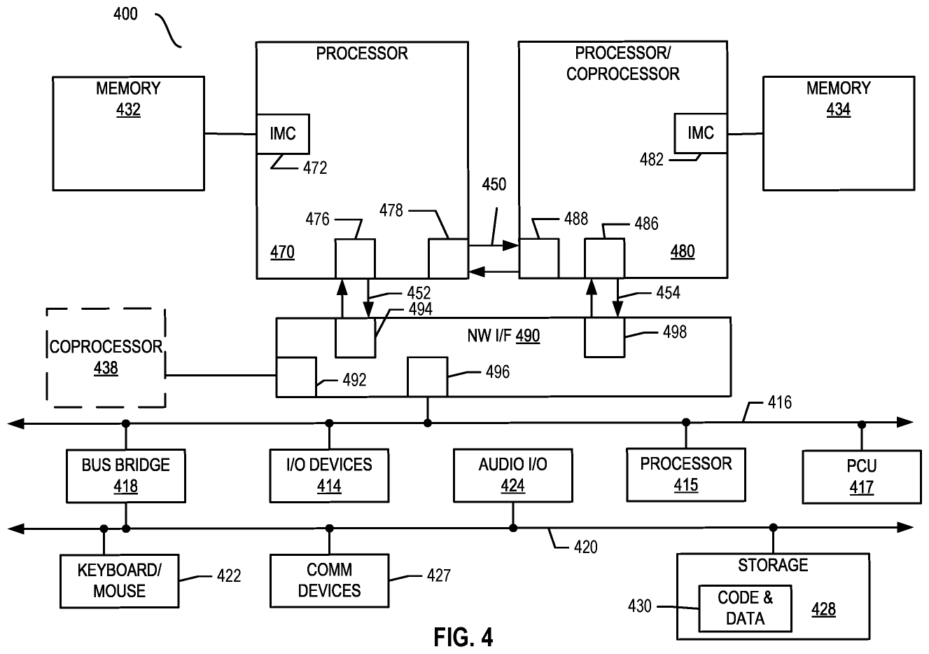

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, first processor 470 and the second processor 480 are heterogenous. Though the example system 400 is shown to have two processors, the system may have three or more processors, or may be a single processor system. In some examples, the computing system is a SoC. In any event, system 400 includes scheduler circuitry as described herein.

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430. Further, an audio 1/O 424 may be coupled to second interface 420. Note that other architectures than the point-to-point architecture described above are possible. For example, instead of the point-to-point architecture, a system such as multiprocessor system 400 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

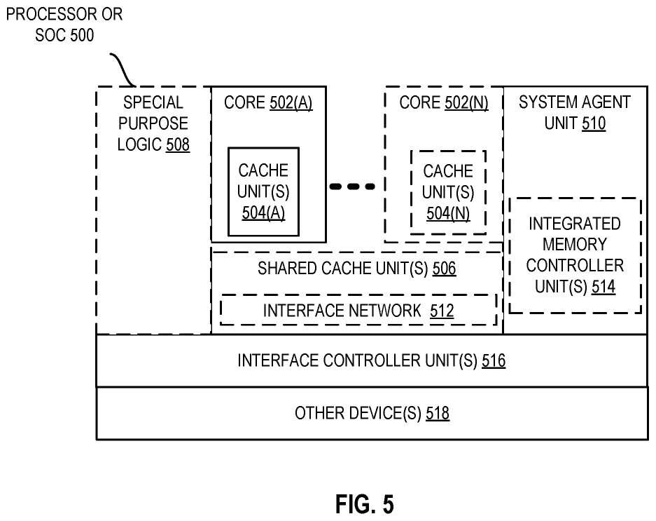

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 570 or 580, or co-processor 538 or 515 of FIG. 5.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays. In various embodiments, cores 502 may include scheduler circuitry that implements the dependency-based techniques described herein, to dynamically update existing reservation station entries based on incoming dependent instructions, realizing more efficient scheduling.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

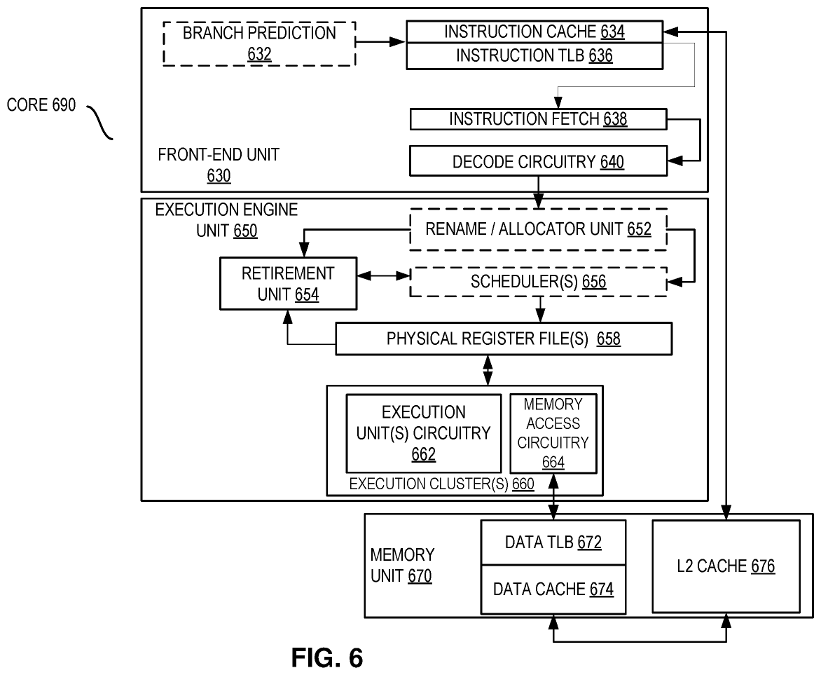

FIG. 6 shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. In various embodiments, the scheduler circuitry 656 can implement the dependency-based techniques described herein, including mechanisms to dynamically update existing reservation station entries based on incoming dependent instructions, to indicate criticality of these producer instructions (of the existing entries).

The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The following examples pertain to further embodiments.

In one example, an apparatus includes: a plurality of execution circuits to execute μops and a scheduler circuit coupled to the plurality of execution circuits, the scheduler circuit to select a first μop based on age information of the first μop, a readiness of the first μop, and a dependency indicator of the first μop, and send the first μop to a first port coupled to at least one of the plurality of execution circuits.

In an example, the scheduler circuit comprises reservation station circuitry, the reservation station circuitry comprising storage for a plurality of entries, each of the plurality of entries to store a μop, readiness information associated with the μop, and a dependency indicator associated with the μop.

In an example, the apparatus further comprises a first storage to store an age matrix, the age matrix comprising a plurality of entries, each of the plurality of entries to store relative age information of a μop with respect to a plurality of other μops stored in the reservation station circuitry.

In an example, the apparatus further comprises an age adjustment circuit coupled to the first storage, the age adjustment circuit to modify the relative age information of the first μop based on the dependency indicator associated with the first μop obtained from the reservation station circuitry.

In an example, the age adjustment circuit is to modify the relative age information of the first μop to be older than at least one μop that was stored into the reservation station circuitry prior to the first μop.

In an example, the age adjustment circuit is to maintain the relative age information of the first μop with respect to a second μop that was stored into the reservation station circuitry prior to the first μop, the second μop having the dependency indicator to indicate that at least one other μop is dependent on the second μop.

In an example, the scheduler circuit comprises a first picker circuit and a second picker circuit, the first picker circuit coupled to the age adjustment circuit and the second pricker circuit coupled to the first storage.

In an example: the first picker circuit is to select the first μop based at least in part on the modified relative age information of the first μop obtained from the age adjustment circuit; and the second picker circuit is to select another μop based at least in part on the relative age information of the another μop obtained from the first storage.

In an example, in response to an incoming μop to the reservation station circuitry that is dependent on the first μop, the reservation station circuitry is to set the dependency indicator of the entry for the first μop to indicate that at least one other μop is dependent on the first μop.

In another example, a method comprises: receiving, in a scheduler circuit of a processor, an incoming μop; determining whether the incoming μop is dependent on a first μop stored in the scheduler circuit; and in response to determining that the incoming μop is dependent on the first μop, updating an entry in the scheduler circuit associated with the first μop to indicate that the first μop has at least one dependent μop.

In an example, the method further comprises scheduling the first μop ahead of at least one other μop based at least in part on the indication that first μop has at least one dependent μop.

In an example, the method further comprises: scheduling the first μop on a primary port coupled to at least one execution unit; and scheduling the at least one other μop on a secondary port coupled to the at least one execution unit.

In an example, the method further comprises scheduling the at least one other μop ahead of the first μop when the at least one other μop is a non-bypassable μop.

In an example, the method further comprises scheduling the first μop further based on an age of the first μop and a readiness of the first μop.

In an example, the method further comprises updating the age of the first μop based on the indication that the first μop has at least one dependent μop.

In an example, the method further comprises scheduling the first μop ahead of the at least one other μop, the at least one other μop stored in the scheduler circuit earlier than the first μop, based at least in part on the updated age of the first μop.

In an example, the method further comprises in response to determining that the incoming μop is dependent on a flag condition of the first μop, not updating the entry in the scheduler circuit associated with the first μop to indicate that the first μop has the at least one dependent μop.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In yet another example, a system includes a processor and a system memory coupled to the processor. In an example, the processor includes: at least one core to execute instructions and which includes: decoder circuitry configured to decode an instruction into at least one μop; allocation circuitry configured to allocate the at least one μop; scheduler circuitry coupled to the allocation circuitry, the scheduler circuitry to dynamically update age information associated with a first μop in response to receipt in the scheduler circuitry of a second μop dependent on the first μop, the scheduler circuitry to schedule the first μop based at least in part on the updated age information associated with the first μop; and execution circuitry coupled to the scheduler circuitry, the execution circuitry to execute the first μop.

In an example, the scheduler circuitry is to schedule the first μop ahead of at second μop, the second μop stored in the scheduler circuitry earlier than the first μop, based at least in part on the updated age information associated with the first μop.

In an example, the scheduler circuitry is to: schedule the first μop on a first port coupled to the execution circuitry; and schedule at least one other μop on a second port coupled to the execution circuitry.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a plurality of execution circuits to execute micro-operations (μops); and
a scheduler circuit coupled to the plurality of execution circuits, the scheduler circuit to select a first μop based on age information of the first μop, a readiness of the first μop, and a dependency indicator of the first μop, and send the first μop to a first port coupled to at least one of the plurality of execution circuits.

2. The apparatus of claim 1, wherein the scheduler circuit comprises reservation station circuitry, the reservation station circuitry comprising storage for a plurality of entries, each of the plurality of entries to store a μop, readiness information associated with the μop, and a dependency indicator associated with the μop.

3. The apparatus of claim 2, further comprising a first storage to store an age matrix, the age matrix comprising a plurality of entries, each of the plurality of entries to store relative age information of a μop with respect to a plurality of other μops stored in the reservation station.

4. The apparatus of claim 3, further comprising an age adjustment circuit coupled to the first storage, the age adjustment circuit to modify the relative age information of the first μop based on the dependency indicator associated with the first μop obtained from the reservation station circuitry.

5. The apparatus of claim 4, wherein the age adjustment circuit is to modify the relative age information of the first μop to be older than at least one μop that was stored into the reservation station circuitry prior to the first μop.

6. The apparatus of claim 4, wherein the age adjustment circuit is to maintain the relative age information of the first μop with respect to a second μop that was stored into the reservation station circuitry prior to the first μop, the second μop having the dependency indicator to indicate that at least one other μop is dependent on the second μop.

7. The apparatus of claim 4, wherein the scheduler circuit comprises a first picker circuit and a second picker circuit, the first picker circuit coupled to the age adjustment circuit and the second pricker circuit coupled to the first storage.

8. The apparatus of claim 7, wherein:
the first picker circuit is to select the first μop based at least in part on the modified relative age information of the first μop obtained from the age adjustment circuit; and
the second picker circuit is to select another μop based at least in part on the relative age information of the another μop obtained from the first storage.

9. The apparatus of claim 2, wherein in response to an incoming μop to the reservation station circuitry that is dependent on the first μop, the reservation station circuitry is to set the dependency indicator of the entry for the first μop to indicate that at least one other μop is dependent on the first μop.

10. A method comprising:
receiving, in a scheduler circuit of a processor, an incoming micro-operation (μop);
determining whether the incoming μop is dependent on a first μop stored in the scheduler circuit; and
in response to determining that the incoming μop is dependent on the first μop, updating an entry in the scheduler circuit associated with the first μop to indicate that the first μop has at least one dependent μop.

11. The method of claim 10, further comprising scheduling the first μop ahead of at least one other μop based at least in part on the indication that first μop has at least one dependent μop.

12. The method of claim 11, further comprising:
scheduling the first μop on a primary port coupled to at least one execution unit; and
scheduling the at least one other μop on a secondary port coupled to the at least one execution unit.

13. The method of claim 11, further comprising scheduling the at least one other μop ahead of the first μop when the at least one other μop is a non-bypassable μop.

14. The method of claim 11, further comprising scheduling the first μop further based on an age of the first μop and a readiness of the first μop.

15. The method of claim 14, further comprising updating the age of the first μop based on the indication that the first μop has at least one dependent μop.

16. The method of claim 15, further comprising scheduling the first μop ahead of the at least one other μop, the at least one other μop stored in the scheduler circuit earlier than the first μop, based at least in part on the updated age of the first μop.

17. The method of claim 14, further comprising in response to determining that the incoming μop is dependent on a flag condition of the first μop, not updating the entry in the scheduler circuit associated with the first μop to indicate that the first μop has the at least one dependent μop.

18. A system comprising:
a processor comprising:
at least one core to execute instructions, the at least one core comprising:
decoder circuitry configured to decode an instruction into at least one micro-operation (μop);
allocation circuitry configured to allocate the at least one μop;
scheduler circuitry coupled to the allocation circuitry, the scheduler circuitry to dynamically update age information associated with a first μop in response to receipt in the scheduler circuitry of a second μop dependent on the first μop, the scheduler circuitry to schedule the first μop based at least in part on the updated age information associated with the first μop; and
execution circuitry coupled to the scheduler circuitry, the execution circuitry to execute the first μop; and
a system memory coupled to the processor.

19. The system of claim 18, wherein the scheduler circuitry is to schedule the first μop ahead of at second μop, the second μop stored in the scheduler circuitry earlier than the first μop, based at least in part on the updated age information associated with the first μop.

20. The system of claim 18, wherein the scheduler circuitry is to:
schedule the first μop on a first port coupled to the execution circuitry; and
schedule at least one other μop on a second port coupled to the execution circuitry.
